(19) United States
(12) Patent Application Publication
(10) Pub. No.: US 2014/0026159 A1
(43) Pub. Date: Jan. 23, 2014

(54) PLATFORM PLAYBACK DEVICE IDENTIFICATION SYSTEM

(71) Applicants: Craig Davis CUTTNER, Norwalk, CT (US); Elmer Gehman MUSSER, JR., St. James, NY (US)

(72) Inventors: Craig Davis CUTTNER, Norwalk, CT (US); Elmer Gehman MUSSER, JR., St. James, NY (US)

(73) Assignee: Home Box Office

(21) Appl. No.: 13/551,744

(22) Filed: Jul. 18, 2012

(51) Int. Cl. H04N 21/24

(52) U.S. Cl. 725/19

(57) ABSTRACT

Systems and methods are disclosed herein to a computer program product, comprising a tangible computer-readable medium having computer-readable program code embodied therein, the computer-readable program code adapted to be executed to implement a method for identifying a platform type of a device, the method including providing a system, wherein the system comprises distinct software modules, and wherein the distinct software modules comprise a secure beacon generator; receiving, by the secure beacon generator, an audio portion of media content from a content playback module; determining, by the secure beacon generator, a platform type of the device; and generating, by the secure beacon generator, a beacon for integrating with a sound wave of the audio portion of the media content, wherein the beacon includes the determined platform type of the device.

### TECHNICAL FIELD

The present invention relates generally to device identification, and more specifically, to a system configured to identify a type of device playing media content.

### BACKGROUND

Television ratings are very important to both content providers and advertisers. Content providers rely on television ratings to determine which shows are successful, and advertisers rely on television ratings to set a market price for advertising time. Some marketing and advertising research firms or audience rating companies specialize in television ratings, such as Nielsen, Arbitron, TruMedia, and CognoVision. These firms use television rating systems that measure audience size and composition for television programming.

In order to generate television ratings, a firm, such as Nielsen, monitors the viewing habits of a number of target homes. Before any data can be gathered, the firm first requests that a target home or person opt-in to their television viewing habit monitoring program. By opting into the program, the target home agrees to waive some privacy rights. However, the target homes selected by the firms are usually kept a secret, and the firm provides no identity-specific information about the target homes to any third parties, such as advertisers or content providers. Once the target home agrees to the survey, the firm monitors television viewing habits of the target home for a certain amount of time. The firm selects a number of target homes, which is a sample of all the television viewing homes (e.g., in the United States or particular regions), but the sample is large enough to be statistically significant. The firm gathers data regarding the viewing habits of all the target homes in the sample and generates television ratings by extrapolating the data gathered from the target homes.

The firm monitors viewing habits of the target homes by using one of a few different methods. A first method is a viewer “diary” method. In the first method, a person in the target home self-records his or her viewing habits in a journal. The first method is not preferable because it is subject to inaccuracies, such as if a member of the target home forgets something he or she watched or is untruthful. A second method uses a technology kit referred to as a “home unit” to monitor viewing habits. In the second method, the firm connects a component of the home kit known as a set meter to a television to measure the viewing habits of the target home. The set meters give the firm more information than the first method, such as the exact moments a viewer switches channels or turns off the television. Additionally, the set meters are not subject to human error and thereby are more accurate at measuring viewing habits. The home unit may even monitor other devices to gather even more data, such as demographic information. Generally, professionals install the home unit soon after the target home agrees to be included in the monitoring program.

FIG. 1 illustrates the second method of television viewing habit monitoring. As shown in FIG. 1, television content 110 is played on a television 120. The audio of the television content 110 is played through a speaker 125 of the television 120. A set meter 130 receives the audio of the content 110 through a microphone 132 and determines what content 110 is being viewed by implementing either a watermarking module 134 or fingerprinting module 136.

Watermarking is a process of embedding information into a signal that can identify the content. A digital watermark may not be audible to human ears or visible to human eyes, but can be recognized by digital equipment. Most television content contains a watermark, so an audio watermark may be used by the set meter 130 to determine which show is being watched. The watermarked content may be watermarked using an audio algorithm such as Nielsen NASE to uniquely identify the content source. The watermark may further include a time/date stamp, content identification, or a unique numerical assignment, such as an entertainment identifier registry (EIDR) or an international standard audiovisual number (ISAN).

Fingerprinting, on the other hand, is a condensed digital summary of an audio sound that generates a uniqueness algorithm. For example, the condensed digital summary measures perceptual characteristics such as average zero crossing rate, average spectrum, bandwidth, and spectral flatness to identify content. Once the uniqueness algorithm is generated, it is sent to a database to identify the content.

As stated above, the set meter 130 identifies the television content 110 using either the watermark module 134 or the fingerprint module 136. The set meter 130 sends the results of either identification to a server 140 of the firm. The server 140 analyzes the information received from the set meter 130 and creates a report 150.

The second method of viewing habit monitoring may be preferable for households that watch television content primarily or exclusively on a television set. However, more and more content is being viewed on alternative platforms other than a television set. For example, television shows are available to download through digital media stores or to stream through provider websites. The digital content can be viewed on a desktop computer, laptop computer, a tablet computer, a smart phone, a gaming console, or any other device capable of playing the digital information. Some existing technology is capable of detecting watermarks or digital fingerprints of content played on platforms other than a television set, even if headphones or ear buds are used to listen to the media, so the content being watched in target homes that watch television media on platforms other than a television set can still be identified.

However, existing technology does not report the type of platform (e.g., desktop computer, laptop computer, tablet computer, smart phone, gaming device) that is playing the television content. As a result, a firm presumes that the content is watched on a television set.

Watermarking techniques can be used to detect a platform type that is playing media, but given the monitoring technology, each content provider must insert a different watermark into the content for every type of device in order to monitor platforms as well as content. Content providers may find that adding multiple watermarks for every type of device capable of playing content is too large of a burden. But the type of platform viewers are using to watch television content may be valuable information to content providers and advertisers. Thus, technology is desired to assist audience monitoring companies determine the type of platform being used to playback media without requiring multiple watermarks for each item of content provided by the content providers.

Also, because the firms may be protective of the secrecy of the identity of those who consent to their monitoring program, a platform identification method must meet certain privacy requirements. For example, content providers and advertisers cannot receive any identity-specific information about the participants in the monitoring program. Also, any application used to playback television content cannot be aware that the technology is identifying content or a user's identity, as such methods may violate privacy policies. Thus, technology that determines the type of platform used to playback media must also satisfy privacy concerns.

### SUMMARY

The systems and methods described herein attempt to overcome the drawbacks discussed above by providing a system that identifies a device platform that is playing media content by using a beacon that is consistent with privacy policies of audience rating companies. The beacon may be a watermark that is added to and consistent with existing watermarks embedded into the media content. The system that generates the beacon may give advertisers, content providers, and audience rating companies valuable information regarding how much content is being consumed through alternative platforms other than a television set without requiring the content providers to embed multiple watermarks into the media content for each type of device that can playback media content.

In one embodiment, a platform playback device identification system includes a computer program product, comprising a tangible computer-readable medium having computer-readable program code embodied therein, the computer-readable program code adapted to be executed to implement a method for identifying a platform type of a device, the method comprising: providing a system, wherein the system comprises distinct software modules, and wherein the distinct software modules comprise a secure beacon generator; receiving, by the secure beacon generator, an audio portion of media content from a content playback module; determining, by the secure beacon generator, a platform type of the device; and generating, by the secure beacon generator, a beacon for integrating with a sound wave of the audio portion of the media content, wherein the beacon includes the determined platform type of the device.

In another embodiment, a platform playback device identification system, comprises a computer program product, comprising a tangible computer-readable medium having computer-readable program code embodied therein, the computer-readable program code adapted to be executed to implement a method for identifying a platform type of a device, the method comprising: providing a system, wherein the system comprises distinct software modules, and wherein the distinct software modules comprise a secure beacon generator; receiving, by the secure beacon generator, an audio portion of media content; determining, by the secure beacon generator, whether a content watermark is included in audio content; determining, by the secure beacon generator, a platform type of the device; generating, by the secure beacon generator, the beacon, wherein the beacon includes data that identifies the platform type of the device; checking, by the secure beacon generator, if the content watermark is embedded into the audio content at the point in time when the device generates the beacon, if the audio content contains the content watermark; embedding, by the secure beacon generator, the beacon into the audio content, if the content watermark is not currently embedded into the audio content; and outputting, by the device, the audio content that includes the embedded beacon through a speaker.

In yet another embodiment, a computer program product, comprising a tangible computer-readable medium having computer-readable program code embodied therein, the computer-readable program code adapted to be executed to implement a method for identifying a platform type of a device, the method comprising: providing a system, wherein the system comprises distinct software modules, and wherein the distinct software modules comprise a beacon detection module; receiving, by the beacon detection module, a beacon generated from a secure beacon generator of a device, wherein the beacon includes data that identifies the platform type of the device that is emitting the audio of the media content; determining, by the beacon detection module, the platform type of the device; and generating, by the beacon detection module, a report identifying the platform type of the device that is emitting the audio of the media content.

Additional features and advantages of an embodiment will be set forth in the description which follows, and in part will be apparent from the description. The objectives and other advantages of the invention will be realized and attained by the structure particularly pointed out in the exemplary embodiments in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings constitute a part of this specification and illustrate an embodiment of the invention and together with the specification, explain the invention.

FIG. 1 illustrates a technology based viewing habit monitoring method.

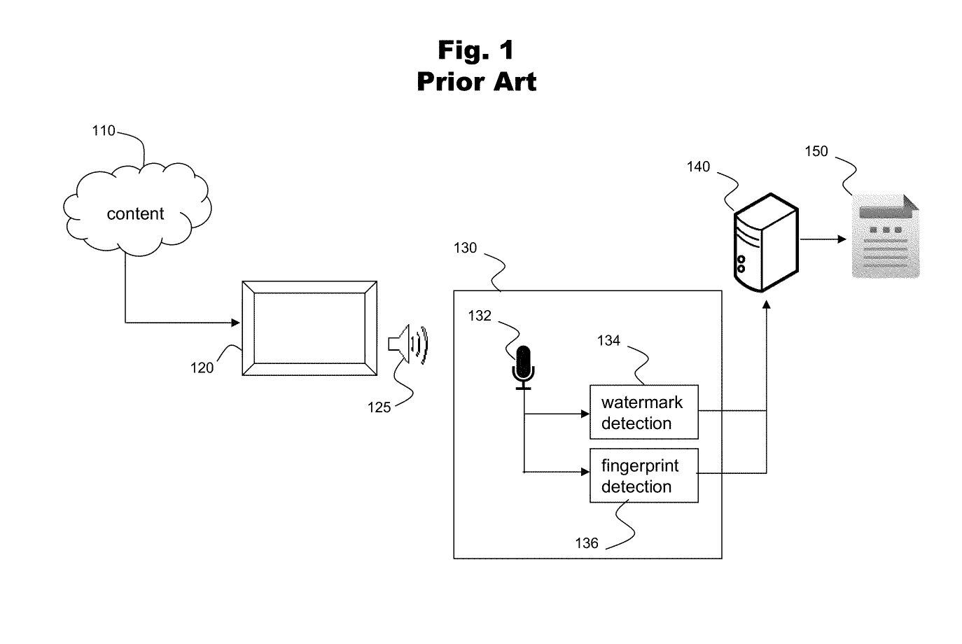

FIG. 2 illustrates the platform playback device identification system according to an exemplary embodiment.

FIG. 3 illustrates modules included in a device for the platform device identification systems according to an exemplary embodiment.

FIG. 4 illustrates an anti-collision characteristic of a beacon according to an exemplary embodiment.

FIG. 5 illustrates a method of emitting a beacon according to an exemplary embodiment.

FIG. 6 illustrates modules included in a device the platform device identification systems according to an exemplary embodiment.

FIG. 7 illustrates a method of emitting a beacon according to an exemplary embodiment.

FIG. 8 illustrates a hardware implementation of the platform device identification systems according to an exemplary embodiment.

FIG. 9 illustrates a method of receiving a beacon by a set meter according to an exemplary embodiment.

### DETAILED DESCRIPTION

Various embodiments and aspects of the invention will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

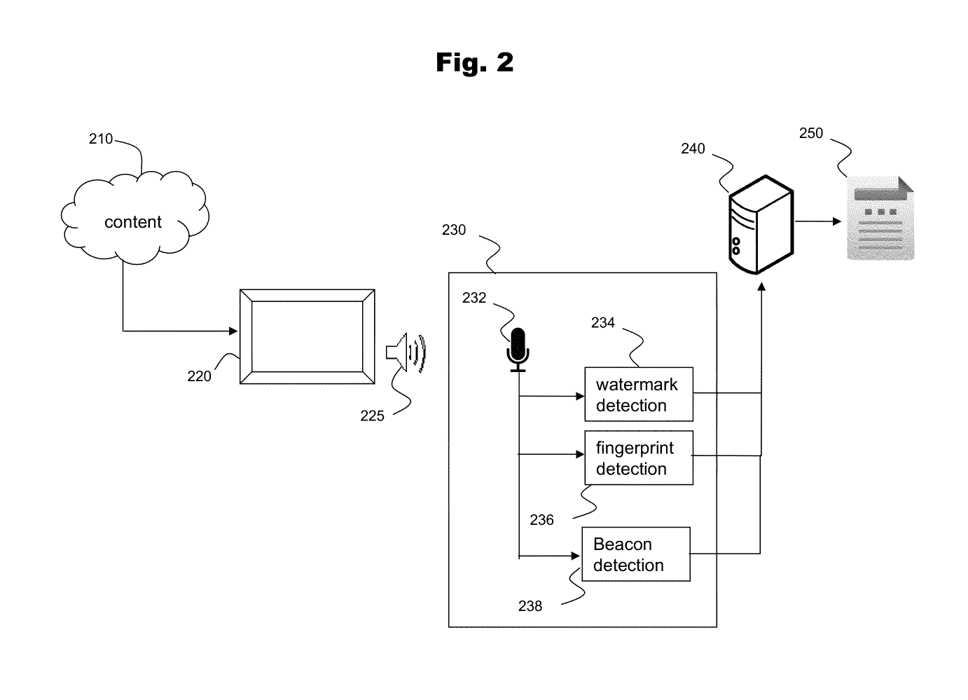

FIG. 2 illustrates a platform playback device identification system according to the exemplary embodiments. As shown in FIG. 2, content 210, which may be a television show, a movie, music, a radio show, a video game, or any other piece of content, from a content provider is played on a device 220. The device 220 may be any device capable of playing media content, such as a television, a gaming console, a tablet computer, a personal computer, a smart phone, or the like. The content provider can be a broadcast television network, a cable television network, a television or movie studio, or any other entity that offers audio, video, or audio and video content for the device 220. The content may be watermarked using an audio algorithm, such as Nielsen NASE, to uniquely identify the content source (e.g., which program and/or which content provider). The watermark may further include a time/date stamp, content identification, or a unique numerical assignment, such as an entertainment identifier registry (EIDR) or an international standard audiovisual number (ISAN). The audio of the content 210 can be played through a speaker 225 of the device 220 or optionally a remote speaker coupled to the device 220. In an embodiment where a remote speaker is used, the remote speaker can be coupled to a stereo system, a computer, or other component for amplifying sound from the device 220. The exemplary embodiment refers to the use of the speaker 225, which can include a speaker integrated into the device 220 or otherwise coupled to the device 220 wirelessly or with wires.

A set meter 230, which can be installed by an audience rating company, can monitor viewing habits of a target home by identifying an audio track of the content 210 from the speaker 225 using a microphone 232. The set meter 230 can be a software module installed in the device 220, an add-on component coupled to the device 220 such as using a USB drive, a set-top box coupled to the device, or any other hardware or software connected with wires or wirelessly to the device 220 for implementing the embodiments described herein. The set meter 230 can be a tangible computer-readable medium having computer-readable program code having modules that can be executed by a processor.

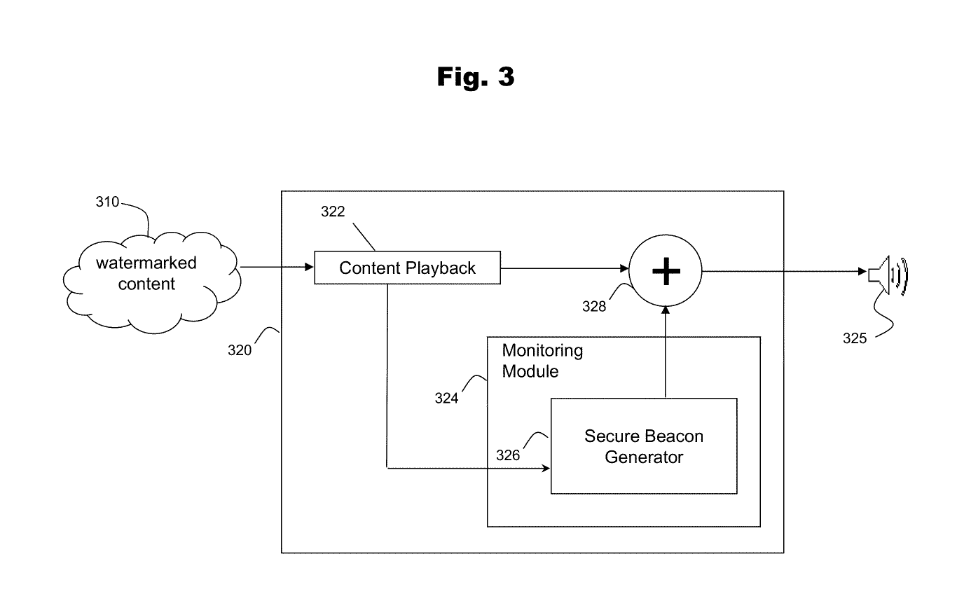

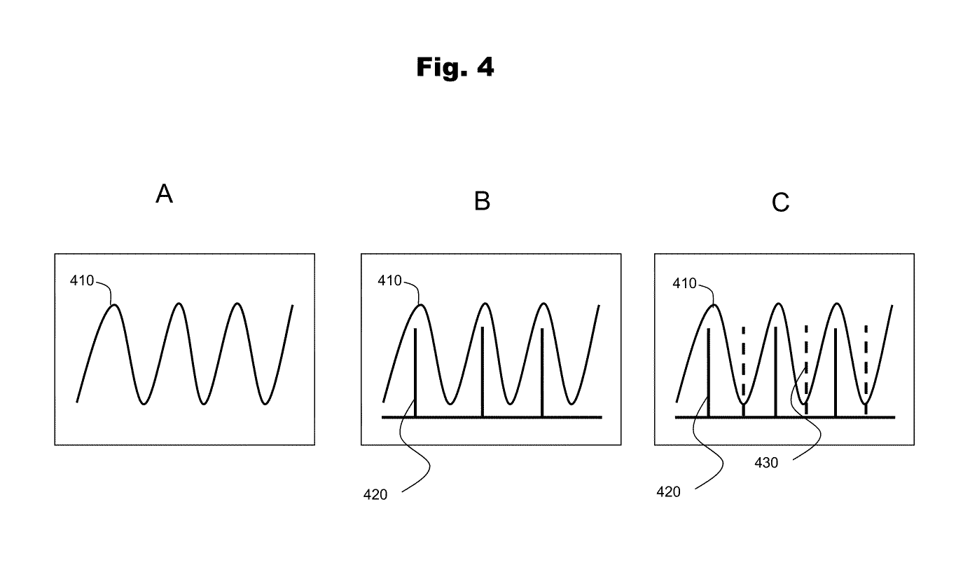

The set meter 230 identifies the content 210 using either a digital watermark detection module 234 or a digital fingerprint detection module 236. In addition, the set meter 230 receives a beacon sent from the device 220 using a beacon detection module 238. The beacon may at least contain information that identifies a platform type of the device 220 that is playing the content 210. The platform type can include a label such as a television, desktop computer, laptop computer, tablet computer, smart phone, gaming console, or the like. The beacon will be described in greater detail below with reference to FIGS. 3 and 4.

The set meter 230 transmits the content identification using the watermark detection module 234 or the fingerprint detection module 236 to a server 210, and the set meter 230 also transmits the platform identification using the beacon detection module 238 to the server 240. The server 240 may be owned and operated by the audience rating company. The server 240 analyzes the information received from the set meter 230 and can create a report 250. The server 240 may include one or more servers and databases that receive information over a network such as the internet, store the received information, and generate reports based upon the stored information.

FIG. 3 illustrates modules included in a device 320 for the platform device identification system. The device 320 includes a content playback module 322 and a monitoring module 324. The content playback module 322 may be a media player implemented by hardware or a software application on the device 320. For many devices, the content playback module 322 may be integrated as part of the device's 320 operating system, and the content playback module 322 may be any multimedia framework capable of handling various formats of digital video, sound, picture, panoramic images, and interactivity. The monitoring module 324 may be implemented by hardware or a software application installed on the device 320. The monitoring module 322 may be implemented as a software package, a mobile “app,” a firmware update, an operating system update, or any other method of updating the device to include the processes and routines of the monitoring module 324. As described above in the background section, a meticulous installation process of a home unit is performed by professionals of the audience rating company before any data is collected. As part of the installation process, the device 320, such as a tablet, a smart phone, a smart television, a gaming console, or the like, may have the monitoring module 324 installed by the audience rating company professionals. Alternatively, the monitoring module 324 may be a software application a user installs before any viewing habits are recorded, an additional hardware component connected to the device 320, or a separate component that is not connected to the device 320, yet capable of receiving media playback from the content playback module 322. The various configurations of the monitoring module 324 will be described in greater detail below.

The monitoring module 324 includes a secure beacon generator 326. The secure beacon generator 326 generates a beacon that identifies the type of platform playing the content 310, and for example, the type of platform may be identified as a tablet, a smart phone, a television, a gaming console, a DVD player, a computer or the like. If the content 310 includes a content watermark that identifies the content 310, the beacon may be a second watermark that identifies the type of device 320. Alternatively, if the content 310 is not watermarked, but instead is recognized using a fingerprint detection module, the beacon may be a first watermark to be output by the device's speaker 325. Additionally, the beacon may be another wired or wireless signal that is configured to identify the platform of the device 320. The secure beacon generator 326 receives the audio of the content 310 and generates the beacon at appropriate points in time. For example, if the content playback module 322 is paused, the secure beacon generator 326 may not output the beacon. As a further example, the secure beacon generator 326 outputs the beacon when the audio of the content 310 is at a certain sound level or when the audio of the content 310 is a certain sound type so that the beacon cannot be heard by a human ear.

The sound of the content 310, which may include a sub-audible watermark identifying the content 310, such as Nielsen NASE, an entertainment identifier registry (EIDR), or an international standard audiovisual number (ISAN), is sent from the content playback module 322 to an audio summing module 328, and the beacon is sent from the secure beacon generator 326 to the audio summing module 328. The audio summing module 328 may be a module included in the monitoring module 324, or the audio summing module 328 may be an audio generating driver included as part of the operating system of the device 320, or the audio summing module 328 may be an additional piece of hardware connected between the device 320 and the speaker 325. In general, the audio summing module 328 includes a combination of a processor, pre-amplifier, amplifiers, stereo balance, equalizer, or the like. The audio summing module 328 mixes the beacon with the audio from the content 310 received from the content playback module 322, which may include a watermark identifying the content 310. In other words, the audio summing device 328 can embed the beacon into the audio signal of the content 310. The speaker 325 outputs the audio of the content 310 and the beacon as sound waves. The beacon, like other conventional watermarks, is sub-audible. Thus, the addition of the beacon signal in the sound wave emitted from the speaker 325 does not distort the audio of the content 310 if the beacon is emitted at an appropriate time, such as when the audio of the content 310 is not silence. However, the microphone 232 of the set meter 230 is configured to detect and receive the beacon, and a beacon detection module 238 is configured to decode the information included in the beacon. It is to be noted that because the beacon is a watermark, the beacon detection module 238 may be unnecessary because the watermark detection module is capable of decoding any watermark, including the beacon. However, the beacon detection module is illustrated as a separate module for illustration purposes.

If the content 310 contains a content watermark identifying the content 310, the beacon is set to not collide with or disrupt the output of the content watermark, as described in more detail in FIG. 4. More specifically, the secure beacon generator 326 does not output the beacon at the same time as the content watermark. If the content watermark and the beacon are output at the same time, the first watermark and/or the beacon may be distorted. For example, the content 310 may include a content watermark that is output through the speaker 325 periodically. The secure beacon generator 326 receives the audio of the content 310 and listens for the watermark of the content 310. In other words, the secure beacon generator 326 determines if the content watermark is being output by the speaker 325 at any given time. In one embodiment, the secure beacon generator 326 may wait for the first watermark to finish outputting through the speaker 325 and subsequently output the beacon. In another embodiment, the beacon may be output at regular intervals that are between intervals when the content watermark is output. So the beacon can be output through the device's speaker 325 between periods of time or pulses when the content watermark is output through the speaker 325. Preferably, the beacon is output immediately after the content watermark is output because the audio of the content 310 at the time immediately following the output of the watermark is likely still an appropriate sound level or sound type for outputting watermarks.

The anti-collision characteristic is illustrated in FIGS. 4A, 4B, and 4C. FIG. 4A illustrates an audio sound wave 410. FIG. 4B illustrates the audio sound wave 410 including a content watermark 420, which is illustrated as a solid line. As shown, the content watermark 420 is output at periodically. While the content watermark 420 is illustrated as a line, this is for illustration purposes only, and the content watermark is actually a signal that is part of the sound wave 410. In the illustration of FIG. 4B, the content watermark 420 is embedded into the sound wave 410 at regular periods to provide information about the content. This is for illustration purposes only, and the content watermark 420 may not be output regularly. FIG. 4C illustrates the audio sound wave 410 including the content watermark 420 and a beacon 430, which is illustrated as a dashed line. Like the content watermark 420, the beacon 430 may also be output at regular periods, but the beacon is not limited to being output at regular periods. Also like the content watermark 420, the beacon 430 is actually a signal embedded into the sound wave 410. As can been seen, the content watermark 420 and the beacon 430 are output at different points in time, and the beacon 430 may be output between two consecutive content watermark “pulses.” Also, as noted above, the beacon 430 and the content watermark 420 may not be periodically output at all times because the sound track of the content 410 may not always be at an appropriate sound level or sound type for watermarking. For example, during a prolonged silence in the sound track of the content 410, no watermarks may be output during the prolonged silence.

Referring again to FIG. 3, if the content 310 does not contain a watermark, and fingerprinting technology is used by the set meter 230 to identify the content 310, the timing of the beacon does not matter because of the nature of fingerprinting technology. Fingerprinting technology identifies content by analyzing a predetermined amount of sound. The timing and frequency of the beacon has no effect on fingerprinting identification. Thus, if no watermark is included in the content 310, the secure beacon generator 326 may periodically output the beacon without any restrictions other than those inherently imposed by the sound track of the content 310.

The information included in the beacon may include any information useful in determining the platform playing the content 310. For example, the secure beacon generator 326 may include a manufacturer's serial number of the device. The serial number could be used by the beacon detection module to determine the type of device playing the content 310. Alternatively, the beacon could include a user-set parameter, such as the name given to the device when the device was first activated by the user. In another embodiment, the professionals who install the home unit may identify the device 320 and program the type of device into the secure beacon generator 326. In yet another embodiment, the secure beacon generator 326 may be able to look into the device's memory and determine the type of device using the information gathered from the device's memory. Those skilled in the art will recognize that the secure beacon generator 326 may determine the device's type in a plurality of methods, and any method that determines the device's type may be included in the scope of the exemplary embodiments to determine the type of device.

The device platform type reported by the beacon may be general or specific. For example, the beacon may generally report that the device 320 is a tablet computer. The beacon may also be more specific, such as by listing a manufacturer and model of the tablet (for example, the beacon may report the device is an Apple® iPad®). Even more specifically, the beacon may report a model generation (for example, the beacon my report that the device is an Apple® iPad 2®). As described above, the beacon may even report the device's serial number or a UPC number. Any information that describes the device's type may be included within the scope of the exemplary embodiments.

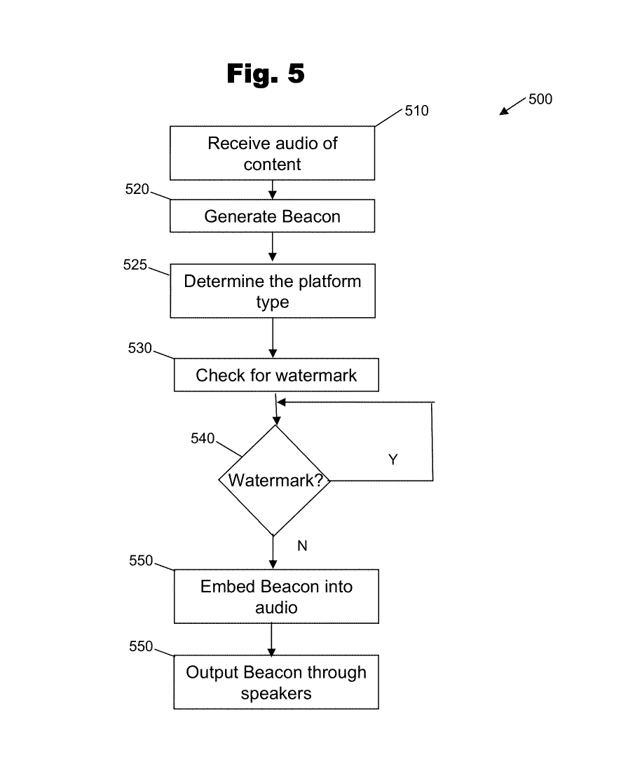

A method of the configuration of the platform playback device identification system of FIG. 3 is shown in FIG. 5. Referring to FIG. 5, in step 510, the monitoring module 324 receives the audio of the content 310 from the content playback module 322. In step 520, the secure beacon generator 326 generates the beacon. In step 525, the monitoring module 324 determines the platform type. In step 530, the monitoring module 324 analyzes the audio of the content 310 to determine if a watermark is currently being output. If in step 540 the monitoring module 324 determines that no watermark is currently present in the content 310, the method 500 continues to step 550. If a watermark is present, the method 500 repeats step 540 until no watermark is detected by the monitoring module 324. In step 550, the audio summing module 328 embeds the beacon into the audio of the content 310. The audio summing module sends the audio of the content 310 including the embedded beacon to the speaker to output the beacon in step 560.

As shown in FIG. 3, the secure beacon generator is part of the monitoring module 324, which is separate from the content playback module 322. As a result, the content playback module 322 may not be aware that the secure beacon generator 326 is identifying the device 320 playing the content 310. For example, the secure beacon generator 326 may run in the background while the content playback module 322 plays the content 310. Because the content playback module 322 is unaware of the actions of the secure beacon generator 326, the audience rating company's secrecy and privacy requirements may be met.

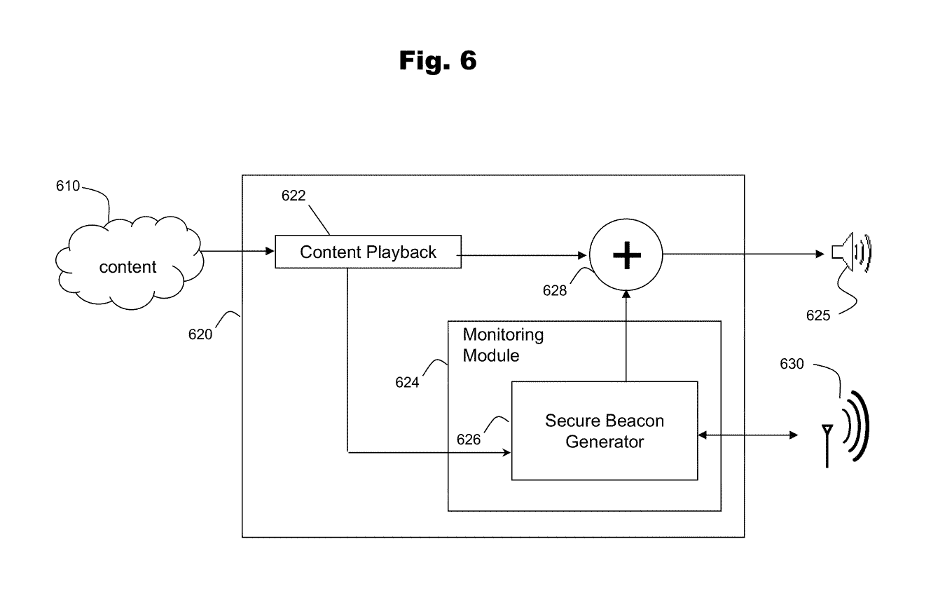

FIG. 6 illustrates the modules included in a device 620 according to another exemplary embodiment. The watermarked content 610 is played using a content playback module 622. A monitoring module 624 is also included in the device 620. The sound of the content 610, which may include a content watermark, is output to an audio summing module 628. A secure beacon generator 626, which is included in the monitoring module 624, may output a beacon to the audio summing module 628. The summing device is configured to embed the beacon into the audio of the content 610, which may include a content watermark. The sound of the content 610 and the beacon is output to the speaker 625. However, in the embodiment of FIG. 6, the secure beacon generator 626 is also connected to a wireless antenna 630. The wireless antenna 630 may be connected to Wi-Fi, 3G, 4G, EDGE, or any other local area or wide area wireless network. Alternatively, the device 620 may be connected through a wired connection, such as Ethernet, USB, or the like. The secure beacon generator 626 transmits the beacon through either the speaker 625 or the wireless antenna 630 depending on the location or status of the device 620. For example, if the device 620 is a smart phone, the device 620 may not be close enough to the set meter to transmit the beacon audibly. Instead, the secure beacon generator 626 sends the beacon over the network that the wireless antenna 630 is connected to. Alternatively, the secure beacon generator 626 may use the wireless antenna 630 to determine whether the device 620 is connected to or within range of the set meter. If the device 620 is not connected to set meter, the device 620 may cache the beacon until the set meter can receive the beacon. In this exemplary embodiment, content 610 consumed while on the go or away from home can also be monitored by the audience rating company.

Information received from the wireless antenna 630 may be included in the information of the beacon. For example, the device 620 may be configured to determine a location of the device 620 and a time of day using information received by the wireless antenna 630. The location, time, etc. may be included in the beacon.

The monitoring module 624 may include additional features that gather additional information about the device 620 that can be reported through the beacon. For example, the monitoring module 624 may be able to determine a state of the device 620, such as an orientation of the device 620, if the device 620 is equipped with an accelerometer, whether headphones are used to listen to the audio of the content 610, the location of the device 620, if the device 620 includes location determining hardware or to what wireless network the device 620 is connected, if the device 620 includes a wireless antenna. Further, the monitoring module 624 may be able to report a status of the content playback module 622, such as whether the content 610 is paused, whether the playback is continuous, and whether a user has used a fast forward or rewind function. Any such information about the device 620 or the playback of the content 610 may be included in the beacon.

The monitoring module 624 may also be able to determine biometric information about a viewer watching the content 610. For example, the monitoring module 624 may determine which viewer in the target home is watching the content 610 when the content playback module 622 begins to play the content 610. The monitoring module 624 may use facial recognition or fingerprint recognition to determine the biometric data. Once the viewer is recognized, the secure beacon generator 626 may report which viewer is watching the content 610 by including such information in the beacon. Viewer recognition and determination may be useful in demographic statistics gathering.

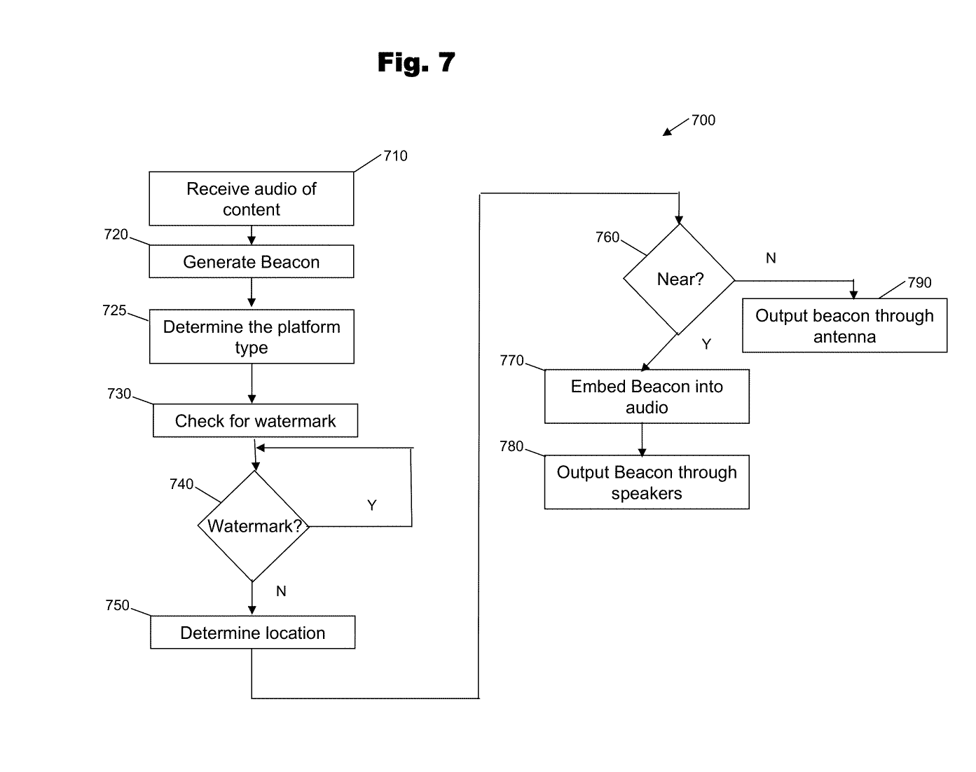

A method of the configuration of the platform playback device identification system of FIG. 6 is shown in FIG. 7. Referring to FIG. 7, in step 710, a monitoring module receives the audio of the content from the content playback module. In step 720, a secure beacon generator generates a beacon. In step 725, the monitoring module determines a platform type. In step 730, the monitoring module analyzes the audio of the content to determine if a watermark is currently being output. If in step 740, the monitoring module determines that no watermark is currently present in the content, the method 700 continues to step 750. If a watermark is present, the method 700 repeats step 740 until no watermark is detected by the monitoring module. In step 750, the monitoring module determines the location of the device, which may be using a wireless antenna, a GPS system, accessing the memory, user prompt, or any other method to determine the location of the device. In step 760, the monitoring module determines if the device, is near the set meter using the location determined in step 750. If the device is within a designated range, the audio summing module embeds the beacon into the audio of the content in step 770 and outputs the audio of the content including the embedded beacon through the speaker in step 760. If the monitoring module determines the device is not within the designated range in step 760, the monitoring module outputs the beacon through the wireless antenna 790. In another embodiment, if the device is not within the designated range, the monitoring module stores the beacon in memory and outputs the beacon when the device is determined to be within the designated range.

The monitoring module 624 may be included as software installed on a device 620. The software may be installed as an application (or “app”) on a smart phone, tablet computer, gaming console, digital media receiver, personal computer, or other device such as a smart TV that allows installation and use of applications. The monitoring module 624 may also be included in a firmware update for any device.

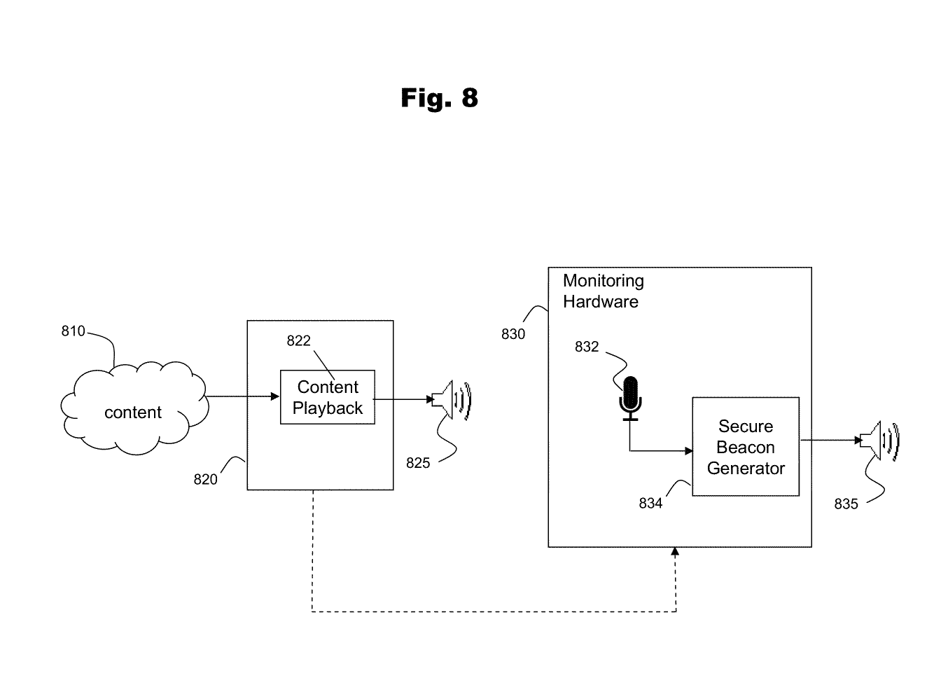

However, not all device that are capable of presenting content are able to be easily updated with a simple software application or firmware update. FIG. 8 illustrates an example of a separate piece of hardware acting as the monitoring module. Referring to FIG. 8, content 810 is played on a device 820 through a content playback module 822 and the audio of the content 810 is output through the speaker 825. Monitoring hardware 830, which may or may not be connected to the device 820, includes a microphone 832, a secure beacon generator 834, and another speaker 835. The microphone 832 receives the audio of the content 810 emitted from the speaker 825 of the device 820. The secure beacon generator 834 receives the audio from the microphone 832, checks for watermarks in the content 810, and generates a beacon. The beacon is output through the speaker 835 of the monitoring hardware 830 This hardware monitoring module 830 may be an option for older televisions that cannot download additional software.

Finally, if a device cannot be updated with a firmware or software monitoring module 624, the set meter 230 may presume that if no beacon is received, the device that could not be updated is the device playing the content 610. Although, this solution may not be preferable if more than one device cannot be updated with the monitoring module 624.

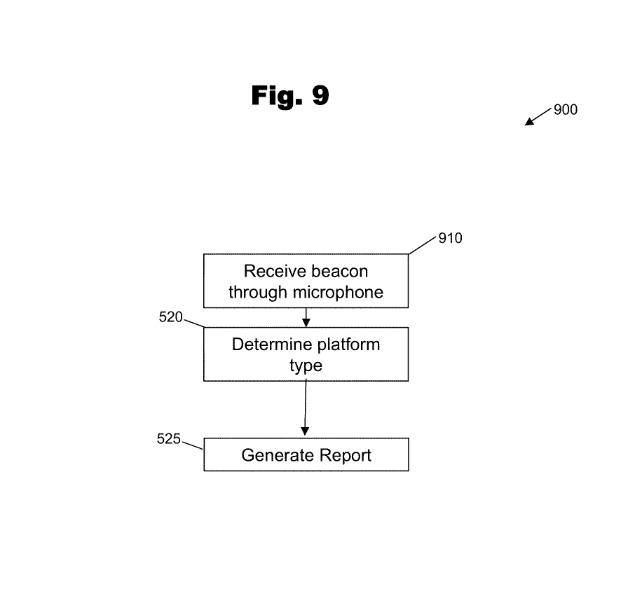

FIG. 9 illustrates a method of receiving the beacon by the set meter 230 according to an exemplary embodiment. Referring to FIGS. 2 and 9, after the beacon has been output by a speaker 225 of the a device 220 or a wireless antenna of the device 230, the set meter 230 receives the beacon through the microphone in step 910. If the beacon is not sent audibly, the set meter 230 may receive the beacon through a network, such as the Internet, LAN, WAN, or any other type of network. The set meter 230 determines the type of platform watching content 210 in step 920. The beacon detection module 238 may be configured to decode the beacon to determine all the information contain in the beacon. The beacon detection module 238 may decode the platform type as well as all the other information that may also be included in the beacon such as biometric data, location data, device status data, and all the other things discussed above. After the device platform has been determined in step 920, the set meter generates a report in step 930 that includes the device platform used to playback the content 210.

The exemplary embodiments can include one or more computer programs that embody the functions described herein and illustrated in the appended flow charts. However, it should be apparent that there could be many different ways of implementing aspects of the exemplary embodiments in computer programming, and these aspects should not be construed as limited to one set of computer instructions. One or more acts described herein may be performed by hardware, software, or a combination thereof, as may be embodied in one or more computing systems.

The functionality described herein can be implemented by numerous modules or components that can perform one or multiple functions. Each module or component can be executed by a computer, such as a server, having a non-transitory computer-readable medium and processor. In one alternative, multiple computers may be necessary to implement the functionality of one module or component.

Unless specifically stated otherwise as apparent from the following discussion, it is appreciated that throughout the description, discussions utilizing terms such as “providing” or “receiving” or “generating” or “processing” or “computing” or “calculating” or “determining” or “displaying” or “checking” or “embedding” or “outputting” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices.

The exemplary embodiments can relate to an apparatus for performing one or more of the functions described herein. This apparatus may be specially constructed for the required purposes, or it may comprise a general purpose computer selectively activated or reconfigured by a computer program stored in the computer. Such a computer program may be stored in a machine (e.g. computer) readable storage medium, such as, but is not limited to, any type of disk including floppy disks, optical disks, CD-ROMs and magnetic-optical disks, read only memories (ROMs), random access memories (RAMs) erasable programmable ROMs (EPROMs), electrically erasable programmable ROMs (EEPROMs), magnetic or optical cards, or any type of media suitable for storing electronic instructions, and each coupled to a bus.

The exemplary embodiments described herein are described as software executed on at least one server, though it is understood that embodiments can be configured in other ways and retain functionality. The embodiments can be implemented on known devices such as a personal computer, a special purpose computer, cellular telephone, personal digital assistant (“PDA”), a digital camera, a digital tablet, an electronic gaming system, a programmed microprocessor or microcontroller and peripheral integrated circuit element(s), and ASIC or other integrated circuit, a digital signal processor, a hard-wired electronic or logic circuit such as a discrete element circuit, a programmable logic device such as a PLD, PLA, FPGA, PAL, or the like. In general, any device capable of implementing the processes described herein can be used to implement the systems and techniques according to this invention.

It is to be appreciated that the various components of the technology can be located at distant portions of a distributed network and/or the Internet, or within a dedicated secure, unsecured and/or encrypted system. Thus, it should be appreciated that the components of the system can be combined into one or more devices or co-located on a particular node of a distributed network, such as a telecommunications network. As will be appreciated from the description, and for reasons of computational efficiency, the components of the system can be arranged at any location within a distributed network without affecting the operation of the system. Moreover, the components could be embedded in a dedicated machine.

Furthermore, it should be appreciated that the various links connecting the elements can be wired or wireless links, or any combination thereof, or any other known or later developed element(s) that is capable of supplying and/or communicating data to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

The embodiments described above are intended to be exemplary. One skilled in the art recognizes that numerous alternative components and embodiments that may be substituted for the particular examples described herein and still fall within the scope of the invention.

What is claimed is:

1. A computer program product, comprising a tangible computer-readable medium having computer-readable program code embodied therein, the computer-readable program code adapted to be executed to implement a method for identifying a platform type of a device, the method comprising:
providing a system, wherein the system comprises distinct software modules, and wherein the distinct software modules comprise a secure beacon generator;
receiving, by the secure beacon generator, an audio portion of media content from a content playback module;
determining, by the secure beacon generator, a platform type of the device; and
generating, by the secure beacon generator, a beacon for integrating with a sound wave of the audio portion of the media content, wherein the beacon includes the determined platform type of the device.

2. The method of claim 1, wherein beacon is output through a wireless antenna.

3. The method of claim 2, wherein the beacon further includes data that communicates a location of the device when the content playback module is playing the media content on the device, a time of day when the content playback module is playing the media content on the device, and a network that the wireless antenna is connected to when the content playback module is playing the media content on the device.

4. The method of claim 1, wherein the beacon further includes data that communicates an orientation of the device when the content playback module is playing the media content on the device, whether headphones are connected when the content playback module is playing the media content on the device, whether playback is continuous while the content playback module is playing the media content on the device, whether the content playback module has performed a rewind or fast forward operation while the content playback module is playing the media content on the device.

5. The method of claim 1, wherein the beacon further includes biometric data that identifies the user of the device in the beacon.

6. The method of claim 1, wherein the beacon is output through a speaker.

7. The method of claim 6, wherein the secure beacon generator is further configured to detect if and where a content watermark is embedded in the audio portion of the media content.

8. The method of claim 1, wherein the beacon communicates the serial number of the device.

9. The method of claim 1, wherein the secure beacon generator determines the device platform type by accessing the memory of the device.

10. The method of claim 1, wherein the secure beacon generator is included as a module on the device.

11. The method of claim 1, wherein the secure beacon generator is separate from the device.

12. A computer program product, comprising a tangible computer-readable medium having computer-readable program code embodied therein, the computer-readable program code adapted to be executed to implement a method for identifying a platform type of a device, the method comprising:
providing a system, wherein the system comprises distinct software modules, and wherein the distinct software modules comprise a secure beacon generator;
receiving, by the secure beacon generator, an audio portion of media content;
determining, by the secure beacon generator, whether a content watermark is included in audio content;
determining, by the secure beacon generator, a platform type of the device;
generating, by the secure beacon generator, the beacon, wherein the beacon includes data that identifies the platform type of the device;
checking, by the secure beacon generator, if the content watermark is embedded into the audio content at the point in time when the device generates the beacon, if the audio content contains the content watermark;
embedding, by the secure beacon generator, the beacon into the audio content, if the content watermark is not currently embedded into the audio content; and
outputting, by the device, the audio content that includes the embedded beacon through a speaker.

13. The method of claim 12, further comprising:
determining, by the device, whether the device is within range of a beacon receiver, before embedding the beacon into the audio content being played by the content playback module;
storing, by the device, data to be included in the beacon in a memory module until the device is within range of the beacon receiver, if the device is determined not to be within range of the beacon receiver;
outputting, by the device, the beacon once the device is within range of the beacon receiver.

14. The method of claim 12, wherein the beacon includes a serial number of the device.

15. The method of claim 12, wherein the beacon further includes data that communicates an orientation of the device when the content playback module is playing the media content on the device, whether headphones are connected when the content playback module is playing the media content on the device, whether playback is continuous while the content playback module is playing the media content on the device, whether the content playback module has performed a rewind or fast forward operation while the content playback module is playing the media content on the device.

16. The method of claim 12, wherein the beacon further includes biometric data that identifies the user of the device in the beacon.

17. A computer program product, comprising a tangible computer-readable medium having computer-readable program code embodied therein, the computer-readable program code adapted to be executed to implement a method for identifying a platform type of a device, the method comprising:
providing a system, wherein the system comprises distinct software modules, and wherein the distinct software modules comprise a beacon detection module;
receiving, by the beacon detection module, a beacon generated from a secure beacon generator of a device, wherein the beacon includes data that identifies the platform type of the device that is emitting the audio of the media content;
determining, by the beacon detection module, the platform type of the device; and
generating, by the beacon detection module, a report identifying the platform type of the device that is emitting the audio of the media content.

18. The method of claim 17, wherein the beacon detection module receives the beacon through a microphone.

19. The method of claim 17, wherein the beacon detection module receives the beacon through a network.

20. The method of claim 12, wherein the beacon detection module determines a serial number of the device.
